(19) United States
(12) Patent Application Publication
(10) Pub. No.: US 2026/0331763 A1
(43) Pub. Date: Oct. 22, 2026

(54) MIMO ANTENNA SYSTEM TO IMPROVE PERFORMANCE OF MOBILE TELECOMMUNICATION DEVICES

(71) Applicant: SkyMirr, Inc., Melbourne, FL (US)

(72) Inventor: Youngmin JO, Melbourne, FL (US)

(21) Appl. No.: 19/441,019

(22) Filed: Jan. 6, 2026

Related U.S. Application Data
(60) Provisional application No. 63/742,327, filed on Jan. 6, 2025.

(51) Int. Cl. H01Q 1/52; H01Q 21/06

(52) U.S. Cl. CPC H01Q 1/523; H01Q 21/062

(57) ABSTRACT

An antenna system. First and second antennas disposed in a proximate relation are concurrently operative such that a first radiated field radiated by the first antenna impinges the second antenna, and a second radiated field radiated by the second antenna impinges the first antenna, thereby reducing effectiveness of the first and second radiated fields. A coupling structure comprising first and second conductive elements each comprises a terminal end and an open end. The terminal end of the first conductive element is connected to the first antenna and the terminal end of the second conductive element is connected to the second antenna.

The surface currents flowing on the coupling structure increase effectiveness of the first and second radiated fields.

### CROSS REFERENCE TO RELATED APPLICATIONS

The present application claims priority under 35 U.S.C. 119(e) to the provisional patent application filed on Jan. 6, 2025 and assigned application No. 63/742,327. The contents of that application are incorporated herein.

### FIELD OF THE INVENTION

The present invention relates to a MIMO (multiple inputs multiple outputs) antenna system that reduces coupling losses (referred to as negative coupling) between proximate antennas and thereby improves the performance of mobile telecommunication devices in which the antennas are incorporated, especially including a wireless telecommunications device that operates according to different wireless technologies at different frequencies, e.g., WiFi and mobile cellular systems.

### BACKGROUND OF THE INVENTION

With the burgeoning of internet and mobile phone connectivity, a user has multiple telecommunications paths to connect her to a site on the world wide web or to her next-door neighbor. Today, the telecommunications industry offers multiple communications paths to reach these and many other destinations, such as legacy copper wires, optical fibers, terrestrial wireless transmissions, and satellite-based communications. Typically, each communications path requires dedicated equipment that operates according to the technical parameters, including assigned frequency bands, and regulations associated with that path.

Telecommunications services have evolved to carry information in many different formats, including voice, video, and data. Multiple and different system operators provide these services and typically multiple CPEs (customer-premises equipment) are required to access these multiple services.

In the telecommunications industry, a CPE comprises a communications device located at a user's/customer's premises and connected to a service provider's network outside the premises. A CPE essentially acts as a bridge between the user's local network and the provider's wide area network.

In one operational mode, the CPE receives signals from a cellular base station via a 4G/5G wireless link, converts the signals to a WiFi data format, and transmits the converted signals to end users on the customer's premise via a WiFi network.

The CPE also transfers data in the opposite direction, i.e., from a user's device to a WiFi network, and from the network to the cellular service providers communications equipment.

Generally, a CPE refers to any communications device that can establish a communications link between two communications devices. Examples include, land line telephones, mobile telephones, smart phones, routers, network switches, residential gateways, set-top boxes, standard and smart televisions, fixed mobile convergence products, home networking adapters, local area networks, wide area networks, and Internet access gateways.

The connection point between the service provider's network and the customer's network is referred to as a demarcation point; the CPE device is located at the demarcation point.

Antennas in CPE devices come in many forms and operate at different frequencies, tailored to specific applications and environments. The antennas are designed to efficiently radiate and receive electromagnetic signals to establish wireless communication between communication devices that operate according to different communications protocols. The CPE operates as a bridge between different networks, such as between a cellular network and a WiFi network.

Performance of a CPE antenna is determined by various factors, such as size, shape, and placement within the CPE device. Available space in the CPE poses a challenge to good antenna design and performance. These factors affect the antenna's ability to radiate and capture electromagnetic waves efficiently, as well as the connection range and the quality of the received and transmitted signals.

Dipole antennas are commonly used in CPE devices because they are simple, easy to install, operate effectively with multiple wireless technologies (e.g., cellular, Bluetooth, Zigbee, WiFi) and their radiation pattern is omnidirectional, which is generally advantageous. A typical dipole antenna comprises a linear conductive element with a length of a half wavelength at the operational frequency of interest. Such a dipole is referred to as half-wavelength dipole antenna.

Many CPEs provide 2×2 and 4×4 MIMO (multiple-input, multiple-output) operation where at least two antennas are operating simultaneously on the same frequency. A 4×4 MIMO operation is a wireless technology that utilizes four antennas at the transmitting end (e.g., a base station) and four antennas at the receiving end (e.g., a smartphone). With this configuration up to four independent and simultaneous parallel signal streams are possible, thereby increasing the overall data throughput and data rate, (when compared to a system employing only a single antenna) by minimizing signal interference, signal fades, etc.

2×2 MIMO operation is similar to 4×4 MIMO operation, but employs only two simultaneously operating antennas at each of the transmitting and receiving ends. And like the 4×4 system, the signal processing component receives both signals and selects the best signal for processing, based on co-relation and probability theory.

In a CPE device, space constraints mandate proximate placement of MIMO antennas, creating problematic coupling-based issues (sometimes referred to as negative coupling) between operating antennas, including: interference between the signals transmitted from or received by each antenna, one antenna affecting the radiated power of another proximate antenna(s), (which leads to distortion, noise, reduced signal power, and reduced signal range), polarization coupling losses due to a polarization mismatch between the antennas, and corruption of the information carried by the transmitted or received signal due to undesired antenna coupling.

A maximum coupling loss (MCL) metric represents the maximum loss that can be tolerated for an operational system. Of course, a higher MCL suggests a more robust link between receiver and transmitter.

Simply increasing a distance between simultaneous operating antennas can reduce coupling and its attendant problems, but an increased separation distance limits design flexibility and disadvantageously increases the size of the CPE device.

Although coupling problems are discussed herein in conjunction with dipole antennas, these coupling problems are applicable to all antenna types.

A conventional CPE providing 4G and 5G MIMO connectivity is not physically large enough to permit adequate spacing between the MIMO antennas. The lack of sufficient spacing creates negative mutual coupling, causing interference between the operating antennas, which results in energy losses and a reduced coverage range.

The telecommunications industry lacks a CPE device that can effectively accommodate MIMO operation for both WiFi and cellular communications services using closely spaced antennas. The present invention provides effective access to both these services with reduced coupling between proximate MIMO antennas.

### BRIEF DESCRIPTION OF THE DRAWINGS

FIG. 1 illustrates two dipole antennas disposed in a closely-spaced parallel configuration.

FIG. 2 illustrates two radiation characteristics for the dipole antennas of FIG. 1 as a function of frequency.

FIG. 3 illustrates a general shape and size of a CPE according to the present invention.

FIG. 4 illustrates the CPE of FIG. 3 and a printed circuit board carrying electronic components within the CPE.

FIG. 5 illustrates a CPE with WiFi and cellular system antennas according to the present invention.

FIG. 6 illustrates two dipole antennas for sending and receiving signals in a cellular communications system.

FIG. 7 illustrates the two dipole antennas of FIG. 6 coupled by a decoupling network.

FIG. 8 illustrates a close-up of the decoupling network of FIG. 7.

FIGS. 9 and 10 illustrate alternative shapes for elements of the decoupling network of FIG. 7.

FIG. 11 illustrates a right-side view of prototype CPE according to the teachings of the present invention

FIGS. 12A and 12B illustrate antenna isolation parameters as a function of frequency before inclusion of the coupling structure (FIG. 12A) and after inclusion of the coupling structure (FIG. 12B).

FIGS. 13A and 13B illustrate a block diagram of the AI/ML training process.

FIG. 14 illustrates a method for executing the AI/ML algorithm.

FIG. 15 illustrates a block of a computer for training and executing the AI/ML algorithm.

FIG. 16A illustrates efficiency in two different frequency bands, FIG. 16B illustrates the voltage standing wave ratio (VSWR), and FIG. 16C illustrates isolation performance parameters of the WiFi antennas of the present invention.

FIG. 17 lists the operational frequency bands for the antennas depicted in FIG. 5.

### DETAILED DESCRIPTION OF THE INVENTION

Unless defined otherwise, all technical and scientific terms used herein have the same meaning as commonly understood by one of ordinary skill in the art to which this invention pertains. Although any methods and materials similar or equivalent to those described herein can be used in the practice or testing of the invention, the preferred methods and materials are now described. All publications mentioned herein are incorporated herein by reference.

The terms “about” or “approximately” as used herein when referring to a measurable value such as a parameter, an amount, a temporal duration, and the like, are meant to encompass variations of and from the specified value, such as variations of +/−10% or less, +/−5% or less, +/−1% or less, and +/−0.1% or less of and from the specified value, insofar such variations are appropriate to perform in the disclosed invention. It is to be understood that the value to which the modifier “about” or “approximately” refers is itself also specifically, and preferably, disclosed.

Reference throughout this specification to “one embodiment”, “an embodiment,” “an example embodiment,” means that a particular feature, structure, or characteristic described in connection with the embodiment is included in at least one embodiment of the present invention. Thus, appearances of the phrases “in one embodiment,” “in an embodiment,” or “an example embodiment” in various places throughout this specification are not necessarily all referring to the same embodiment but may.

Furthermore, the features, structures or characteristics may be combined in any suitable manner, as would be apparent to a person skilled in the art of this disclosure, in one or more embodiments. Furthermore, while some embodiments described herein include some, but not other features included in other embodiments, combinations of features of different embodiments are meant to be within the scope of the invention. For example, in the appended claims, any of the claimed embodiments can be used in any combination.

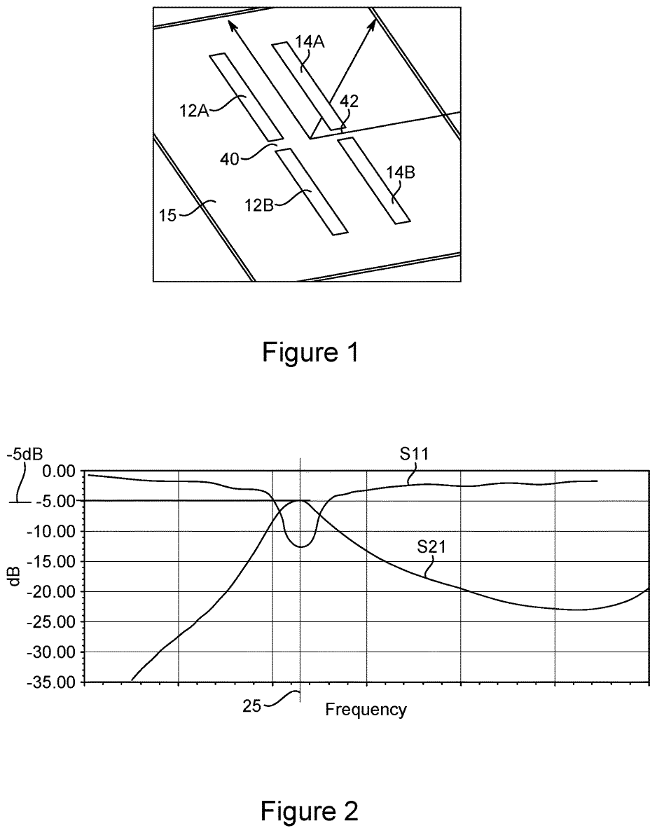

FIG. 1 illustrates a dipole antenna comprising segments 12A and 12B, separated by a feed point 40, and a dipole antenna comprising segments 14A and 14B, separated by a feed point 42. The antennas are disposed in closely-spaced arrangement on a substrate 15 (e.g., a printed circuit board). The close spacing of the antennas induces coupling issues as described above. Each segment of each antenna is connected to a transmission line or ground (not shown), providing a signal feed (a current source or a voltage source).

FIG. 2 graphically depicts port performance parameters (S11 and S21) as a function of frequency for the dipole antennas 12A/12B and 14A/14B.

The S21 parameter curve depicts the signal input to dipole antenna 12A/12B (referred to as antenna 1 or port 1) and output from dipole antenna 14A/14B (referred to as antenna 2 or port 2).

FIG. 2 also illustrates a reflection parameter S11 that indicates the signal power input to dipole antenna 12A/12B (or port 1) and output from dipole antenna 12A/12B (port 1).

Note that an S-parameter with the same numerical subscripts, such as S11, indicates signal reflection measurements, while an S-parameter with different numerical subscripts, like S21, indicates signal transmission measurements. The second numerical value in the subscript indicates an input port and the first numerical value indicates an output port.

With continuing reference to FIG. 2, at a resonant frequency (indicated by a vertical line 25) the S21 parameter peaks at about 31 5 dB, which is higher than desired and caused by lack of sufficient isolation (i.e., the antennas are closely spaced) between the two antennas, which in turn creates unwanted coupling between the two antennas and the signals that the antennas receive and transmit. The failure to sufficiently decouple the antennas 12A/12B and 14A/14B causes antenna operational problems as described above in the Background section. Failure to adequately decouple the antennas is exacerbated in a space-constrained CPE device. The depicted S11 parameter indicates the energy supplied to port 1 (either antenna 12A/12B or the antenna 14A/14B ) and returned/reflected back to the same port, also referred to as the internal reflection coefficient. The S11 is not related to antenna coupling nor indicative of coupling performance.

The disadvantages described for the closely-spaced antennas 12A/12B and 14A/14B are especially problematic when the antennas are mounted in a relatively small CPE device that provides MIMO operation. Most CPEs operate in multiple frequency bands and according to multiple wireless communication standards, which further complicates signal interference problems.

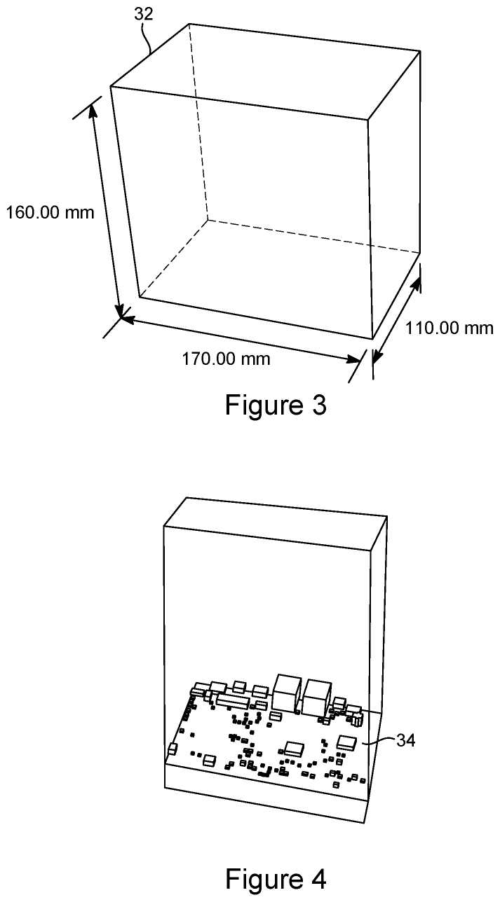

FIG. 3 illustrates a general outline shape and size of a CPE device 32 that comprises antennas designed to provide effective communications according to both WiFi and cellular system technologies and to operate in a MIMO configuration. In one embodiment, the CPE device 32 is 170 mm long, 160 mm high, and 110 mm wide. Other embodiments have different dimensions if the coupling and radiating characteristics of the antennas of the CPE device 32 are not negatively affected or decoupling elements are included between the proximate antennas.

Generally, problematic coupling interference between proximate antennas can be avoided if the antennas are spaced apart by a distance of about λ/4 or farther, where A is the wavelength of the transmitted or received signal. If spaced at a distance of less than about λ/4 a decoupling network to reduce the coupling interference is required.

FIG. 4 depicts a printed circuit board 34 within the CPE device 32 for carrying signal processing components operative with the antennas of the CPE device, such as a controller for controlling operation of the CPE antennas (e.g., a system-on-a-chip), a diplexer for generating a multiple-user MIMO signals, DC power supplies, front-end modules for performing signal processing for each antenna, antenna terminals for connecting additional antennas to the CPE. The functionality of these individual components is well-known to those skilled in the art.

The PCB 34 is located on a lower surface or bottom of the CPE device 32 and the antennas are located within an upper region of the CPE device. This physical arrangement creates a sufficient distance to minimize interference between the antennas and the components on the PCB.

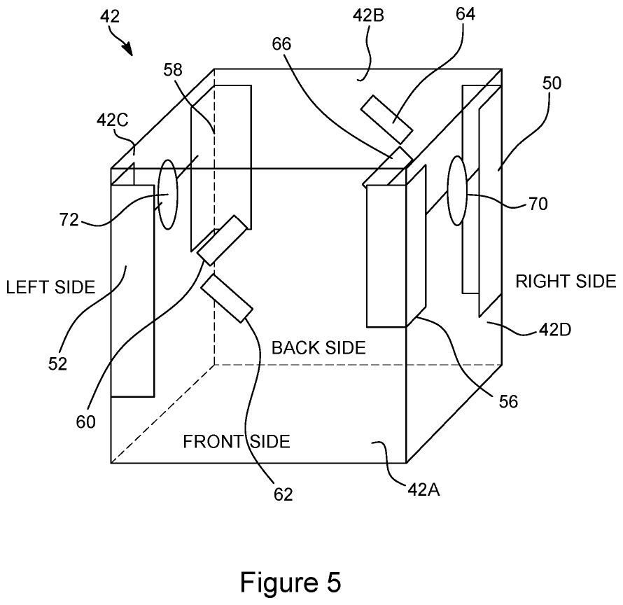

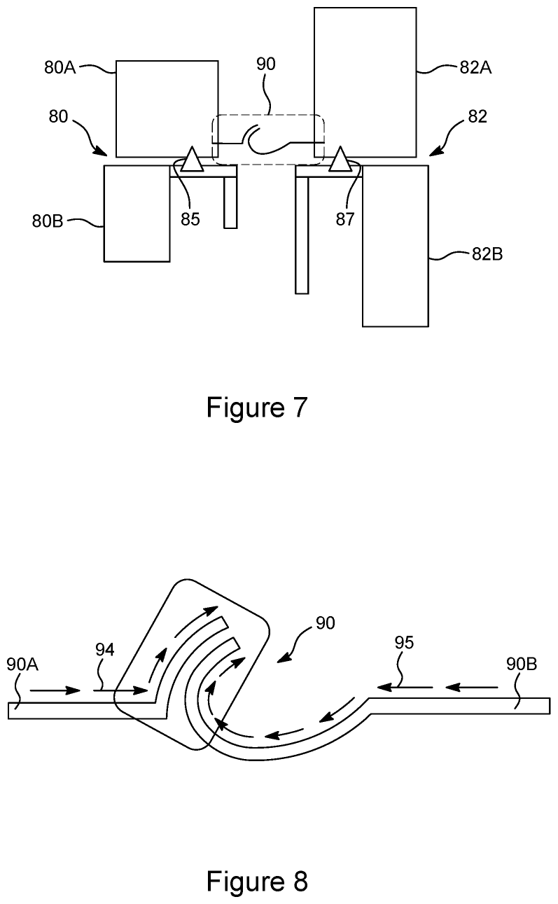

FIG. 5 illustrates a CPE device 42 with antennas and decoupling networks installed at locations that offer measurably improved performance when compared with a CPE device carrying antennas but lacking decoupling networks. Note the decoupling networks are depicted by simple round circles so as not to complicate FIG. 5. In fact, a more detailed depiction is shown in FIGS. 7-10.

The CPE device 42 comprises a front surface 42A, a back surface 42B, a left side surface 42C, and a right-side surface 42D.

FIG. 5 also depicts multiple antennas and decoupling networks designed and located to maximize performance of the CPE device 42. Although the illustrated and described antennas are designated for use in certain frequency bands and according to certain wireless technologies, those skilled in the art appreciate that other operating frequencies and wireless technologies can be accommodated with different antenna designs. The present invention then teaches the design and placement of decoupling networks for use with any such antennas.

Additionally, although the antennas are illustrated as simple rectangles to simplify FIG. 5, those skilled in the art understand that various antenna types can be used in the CPE device, such as dipole antennas, patch antennas, meanderline antennas, monopole antennas, and PIFA antennas (planar-inverted F-antennas), among others.

According to one embodiment, cellular antennas 50 and 52 (disposed at opposing corners of the CPE device 42) are designed for operation according to the 4G LTE and 5G sub 6 cellular standards within the frequency bands of 617-960 MHz, 1447-2690 MHz, and 3300-5925 MHz. 5G sub 6 refers to the use of 5G technology within the frequency spectrum below 6 GHz, which offers a balance between signal coverage and data speed.

Cellular antennas 56 and 58 (depicted as shorter than the cellular antennas 50 and 52 and also disposed at opposing corners of the CPE device 42) are designated for operation according to the 4G LTE and 5G sub 6 cellular standards within the frequency bands of: 1447-2690 MHz and 3300-5925 MHz.

Generally, when antennas are placed in a proximate relationship (such as the antennas 50 and 56 and antennas 52 and 58) negative mutual coupling reduces the radiation performance when the antennas operate simultaneously (for example, during MIMO operation). Simultaneous operation may cause the field generated by a first antenna to negatively affect the field generated by a second antenna. For example, the radiated signal produced by the first antenna generates an electric field at the location of the second antenna. This electric field can drive surface currents at the second antenna and these surface currents can flow in an opposite direction relative to the surface currents generated by the second antenna's source. If the two antennas are located in close proximity, the negative coupling is strong, the generated surface currents are significant, causing field/energy cancellation, thereby resulting in a significant performance reduction of the second antenna.

The negative coupling between proximate antennas can be reduced by simply spacing the antennas at a sufficient distance to minimize the negative coupling. But these spacing requirements mandate a large enclosure, which is undesired in many applications when the antennas are collocated in or on a relatively small CPE device.

Alternatively, or in addition to spacing the antennas at a distance, a coupler (more specifically a decoupler) designed specifically to reduce the negative coupling can be connected to the two antennas. The present invention relates to the design and use of such couplers.

As those skilled in the art are aware, there is no absolute rule for determining the minimum distance between two antennas to avoid negative coupling issues. Some experts recommend a full wavelength distance to avoid this coupling problem, while others recommend a shorter distance. In any case, the present invention permits spacing antennas at less than λ/4 by using the inventive coupling elements.

To reduce coupling and the attendant interference between proximate antennas, two antenna pairs, with two antennas in each pair, are disposed on opposite sides of the CPE device to provide sufficient spacing between the antenna pairs. See FIG. 5. The antennas 50 and 56 comprise one pair located on the right-side surface 42D of the CPE device 42, and the antennas 52 and 58 comprise another pair located on the left-side surface 42C of the CPE device.

The CPE device shape is rectangular (not square) in the x-y plane. This feature provides sufficient spacing as the pairs 50 and 56 are separated by the longer dimension of the rectangle from antennas 52 and 58. Thus, the rectangular shape avoids the need for decoupling elements for the antennas separated by the longer dimension. But decoupling elements are employed for the antennas separated by the shorter dimension of the rectangle. In any case, the rectangular structure minimizes the total volume of the CPE device.

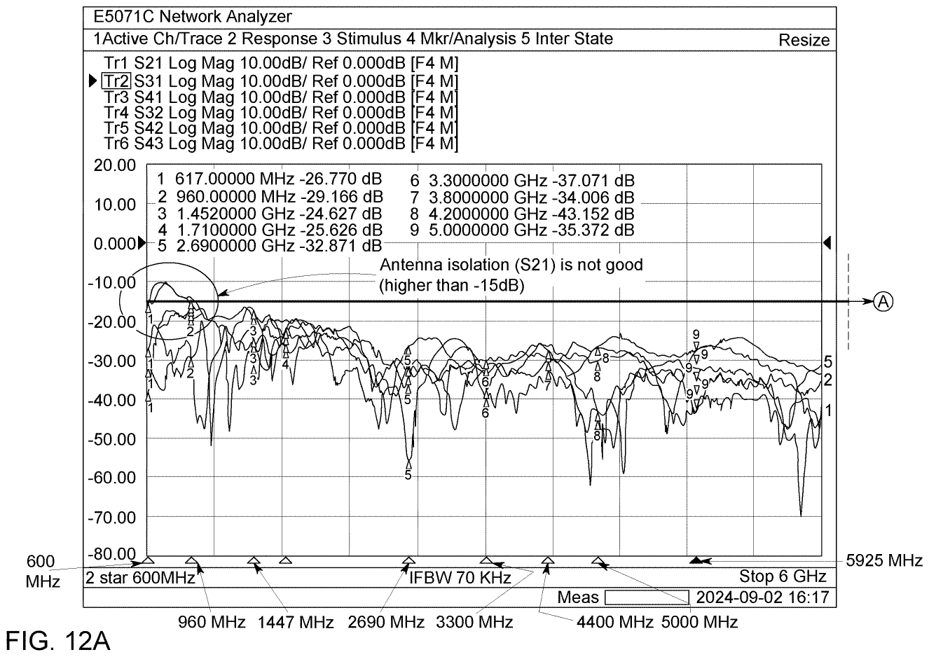

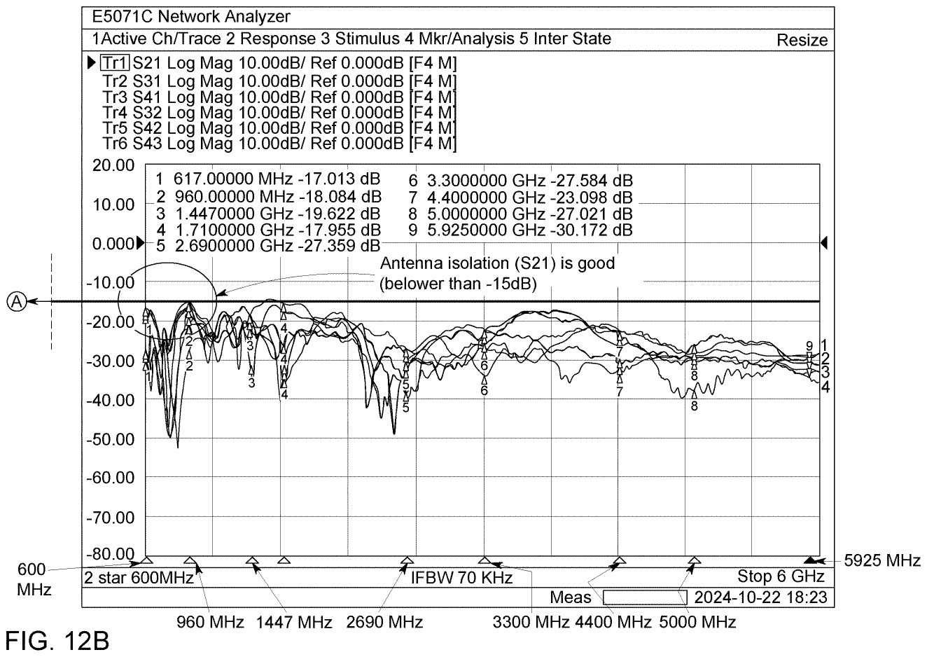

The antennas 50 and 56 (and the antennas 52 and 58) are placed at the corners of the CPE device (see FIG. 5) and separated by the shorter dimension. These antenna pairs are sufficiently close to possibly cause coupling issues. A frequency versus isolation plot of FIG. 12A suggests that improved decoupling of the MIMO antennas, and the resulting improvement in communications between transmitting and receiving devices, can be beneficial.

To improve MIMO antenna performance, each closely spaced antenna pair (50/56 and 52/58) includes a MULCAT (Multi-Layer Coupling Controlled Antenna Technology) coupler for reducing interference between the transmitted and received signals when both antennas are operating. A MULCAT coupler 70 is disposed between 4G LTE/5G antennas 50 and 56 on the right-side surface 42D. Similarly, 4G LTE/5G sub 6 antennas 52 and 58 on the left-side surface 42C are connected by a MULCAT coupler 72.

In one embodiment the MULCAT couplers 70 and 72 are disposed in one layer of a printed circuit board. However, in an embodiment requiring extending the length of each MULCAT coupler some of the conductive lines can be overwrapped in multiple layers, that is, one conductive line above, but insulated from, a second conductive line.

The MULCAT couplers 70 and 72 of FIG. 5 enable the surface currents of individual couplers to generate positive near fields from each surface current so that the fields radiated from each element are added without cancellation, resulting in a combined stronger radiated field, while reducing the negative coupling from each antenna. Additionally, the MULCAT couplers increase the effective aperture of the antennas.

Additional details of the MULCAT couplers 70 and 72 are described in conjunction with FIGS. 7-10 below. MULCAT couplers are also described in co-owned pending patent applications:
Multilayer Coupling-Controlled Ultra Compact Antenna System; application Ser. No. 18/747,795 (Attorney Docket Number 16514-007)
Helical-Shaped Coupling Controlled Compact Antenna System; application Ser. No. 18/747,799 (Attorney Docket 16514-009).

Both patent applications are incorporated by reference herein.

Also depicted in FIG. 5, WiFi antennas 60, 62, 64, and 66 are designated for operation according to the WiFi 7 standard within the frequency bands of: 2400-2500 MHz, 5100-5900 MHz, and 5925-7125 MHz. Antennas 64 and 66 are disposed on the rear surface 42B of the CPE device 42, and antennas 60 and 62 are disposed on the front surface 42A.

Although any one of the antennas in FIG. 5 can be operated independently of the other antennas, improved performance is realized by operating multiple antennas together in a MIMO network to provide higher data rates with improved signal quality when compared with a single antenna (SISO), especially in the presence of interference or low signal strength.

Supporting electronics elements combine or separate the transmitted and received signals as required. MIMO is a key component of modern wireless technologies, including cellular standards 4G LTE and 5G sub 6, and WiFi standards 5, 6, and 7.

The use of 2×2 MIMO technology increases connection speeds by about 30% over a SISO antenna system. Using 4×4 MIMO technology improves the connection speed by about 70% over a SISO system. These benefits can be realized even when data transmission is congested at the cell tower or the WiFi router.

Cellular antennas 50 and 52 (see FIG. 5) are capable of 2×2 MIMO operation in the 617-960 frequency range according to the 4G LTE and 5G standards.

Cellular antennas 50, 52, 56, and 58 are capable of 4×4 MIMO operation in the 1447-2690 MHz and 3300-5925 MHz frequency bands according to the 4G LTE and 5G standards.

WiFi antennas 60, 62, 64, and 66 are capable of 4×4 MIMO operation according to the WiFi 7 standard within the frequency bands of 2400-2500 MHz, 5100-5900 MHz, and 5925-7125 MHz.

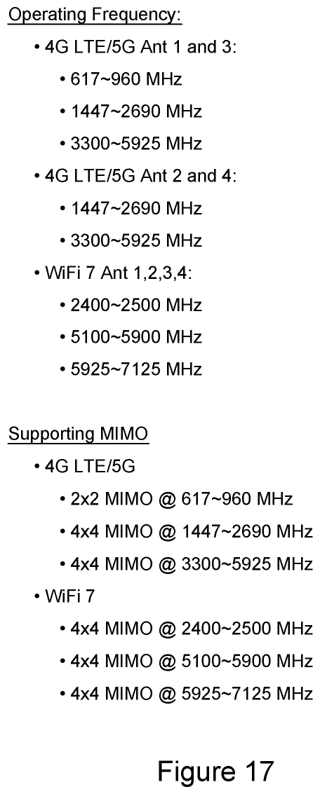

The operational frequency bands for the several antennas depicted in FIG. 5 are set forth in FIG. 17. The MIMO antenna combinations are also set forth in that Figure.

The coupling structures 70 and 72 illustrated generally in FIG. 5 can be implemented by various shaped coupling structures, such as the coupling structures illustrated in FIG. 7-10 as further described below.

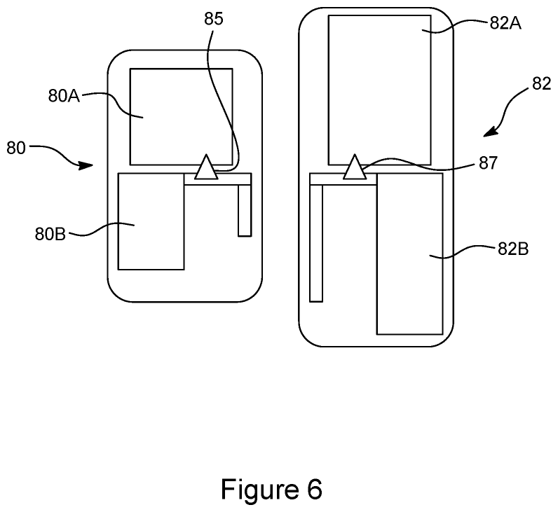

The 4G LTE/5G antennas are depicted in FIG. 5 as simple rectangles (antennas 50, 52, 54, and 56). But preferably, in one embodiment, the antennas 50 and 56 (and the antennas 52 and 58) comprised dipole antennas 80 and 82 of FIG. 6. A coupling structure is not illustrated in FIG. 6. The dipole antenna 80 comprises elements 80A and 80B separated by a gap 80C and similarly the dipole antenna 82 comprises elements 82A and 82B separated by a gap 82C. Signal feed points to the antennas are indicated by triangle symbols 85 and 87.

Also, the antennas 50, 52, 56, and 58 are depicted as disposed on two surfaces of the CPE device 42, this is merely exemplary as in another embodiment each one of these antennas can be disposed on only a single surface or multiple surfaces of the CPE device 42.

In FIG. 7, the dipole antennas 80 and 82 are connected by a MULCAT coupling structure 90 for reducing coupling-induced problems created by the proximate placement of the antennas 80 and 82. Terminal ends of the coupling structure 90 are conductively connected to the respective dipole elements 80A and 82A, as further described below in conjunction with FIG. 8.

As to the lengths of each coupler, antenna designers optimize the lengths while evaluating the interference between two antennas. However, it can help improve the radiation corresponding to the resonant frequency as caused by the coupler.

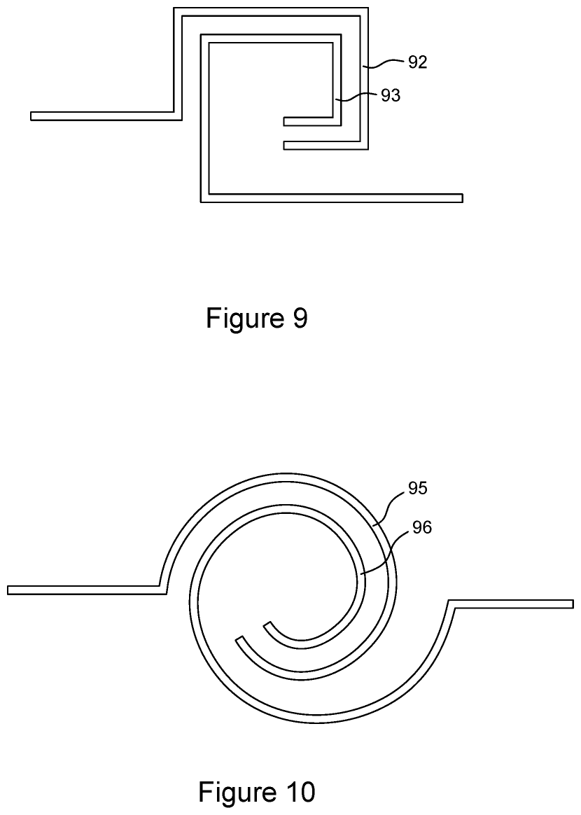

The coupling structures described herein (elements 70 and 72 in FIG. 5 and element 90 in FIGS. 7 and 8, elements 92 and 93 in FIG. 9, and elements 95 and 96 in FIG. 10) radiate electromagnetic fields that are added or combined with the radiated fields from the antennas 80 and 82 (because all the surface currents flow in the same direction) thereby limiting/reducing the interference between radiated fields, resulting in better isolation performance of the antennas 80 and 82 across the frequency spectrum of interest.

According to another embodiment, more specifically described in the referenced co-owned applications, a MULCAT coupling structure has been added to the lower segments 80B and 82B of the dipole antennas 80 and 82 of FIGS. 6 and 7. However, in the illustrated embodiment the lower coupling structure is too close to components on the main PCB, which is located at the bottom of the CPE housing, likely causing noise problems.

The functionality of the coupling structure 90 and its constituent elements, conductive lines 90A and 90B are shown in more detail in FIG. 8. Conductive line 90A is connected to antenna 80 (not shown in FIG. 8) and conductive line 90B is connected to antenna 82 (not shown in FIG. 8). Due to the shape and length of the conductive lines 90A and 90B and the direction of the surface currents 94 and 95, the fields created by the surface currents are in the same direction. Therefore, the radiated fields (e.g., from the antennas 80 and 82 as determined by their source currents and from the surface currents 94 and 95 in the coupling structures) are added, with no cancellation or interference between these fields. This low interference improves performance.

Although the conductive lines 90A and 90B are illustrated as curved structures in FIG. 8, this shape is not required. See FIGS. 9 and 10 for other exemplary shapes that generate surface currents in the same direction and thus generate additive radiated fields.

The coupling structure 90 (and the other coupling structures described herein) can be formed as traces on a printed circuit board, as sheets of copper, or as copper wires.

As to the WiFi antennas 60/62 and the WiFi antennas 64/66 of FIG. 5, according to one embodiment, a coupling structure (such as the coupling structures described herein) to decouple the signals radiated by these WiFi antennas is not required. Instead, the WiFi antennas 60 and 62 (and the WiFi antennas 64 and 66 are disposed at 90 degrees relative to each other (that is, a centerline of the antennas intersect at 90 degrees) such that the antennas 60 and 62 (and the antennas 64 and 66) provide both pattern and polarization diversity and thus the attendant negative coupling problems are minimal. To configure the antennas at 90 degrees separation, the WiFi antenna 60 is placed at a +45 degrees angle relative to horizontal and the WiFi antenna 62 is placed at-45 degrees angle relative to horizontal.

To reduce interference between the 4G/5G antennas 50, 56, 52, 58 and the WiFi antennas 60, 62, 64, 66, a pair of WiFi antennas are disposed between the 4G/5G antenna pairs on the CPE enclosure. Specifically, a first pair of WiFi antennas 60 and 62 is disposed between 4G/5G antennas 52 and 56 on the front surface 42A of the CPE device 42. A second pair of WiFi antennas 64 and 66 is disposed between 4G/5G antennas 50 and 58 on the rear surface 42B of the CPE device 42.

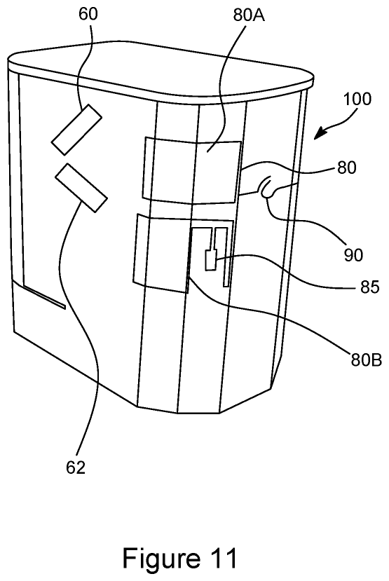

FIG. 11 illustrates a front-side perspective view of a CPE device 100, including the cellular and the WiFi antennas 60 and 62 as depicted in FIG. 5 and the cellular antenna 80 from FIGS. 6 and 7.

FIGS. 12A and 12B illustrate the improvement in the S21 antenna parameter. As can be seen in FIG. 12A, the S21 parameter is above-15 dB in the low frequency range without use of the coupling structure of the present invention. FIG. 12B shows the improvement, that is, all S21 values are below the −15 dB threshold after implementing the coupling structure as taught by the present invention.

For MIMO antenna systems, coupling problems are present in both the transmit and receive operating mode. Thus, the coupling structures taught by the present invention provide beneficial antenna performance in both operating modes. Additionally, although the present invention is described relative to a 4×4 MIMO antenna array, the teachings of the invention can also be applied to a 2×2, 8×8, and 16×16 antenna array to reduce coupling between simultaneously operating antennas.

In one embodiment the system comprises two MULCAT couplers between two pairs of two cellular antennas, one pair on each end of the CPE. The electronic signal processing then combines the two pairs together to achieve 4×4 MIMO in this case.

Furthermore, the technology described herein can be extended in another embodiment where a set of 4×4 antennas and attendant couplers, allow all four antennas to be closely spaced together and constructive coupling is achieved amongst all four.

Generally, a length of the coupling structures, such as those depicted in FIGS. 7-10, is proportional to a length of the coupled antenna elements. However, in certain applications and embodiments the length of the coupling structures may be less significant since the coupling structures may not contribute significantly to the formation of the radiated fields, and conversely in energizing the antenna by a received field.

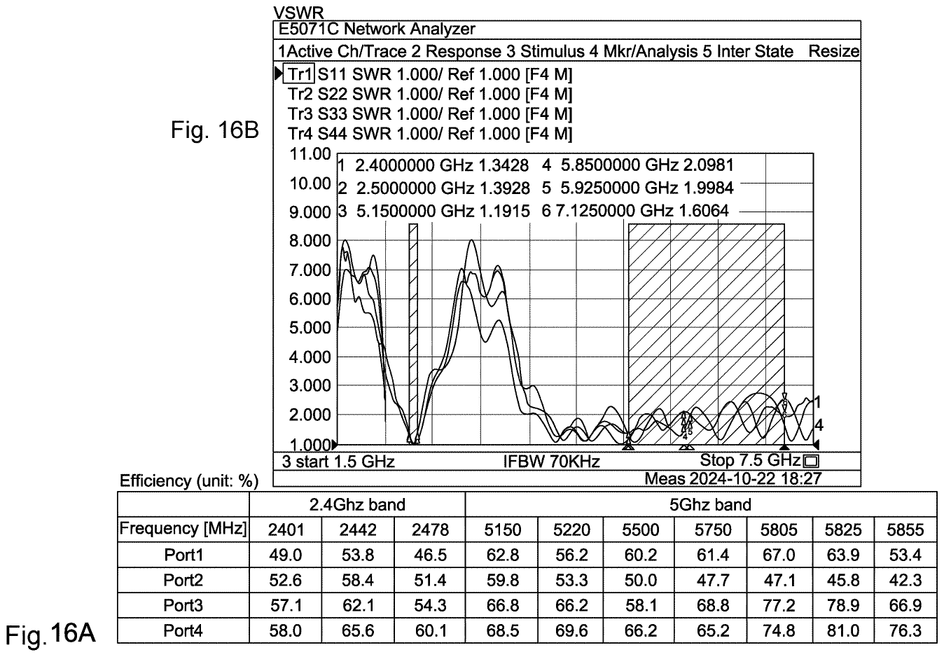

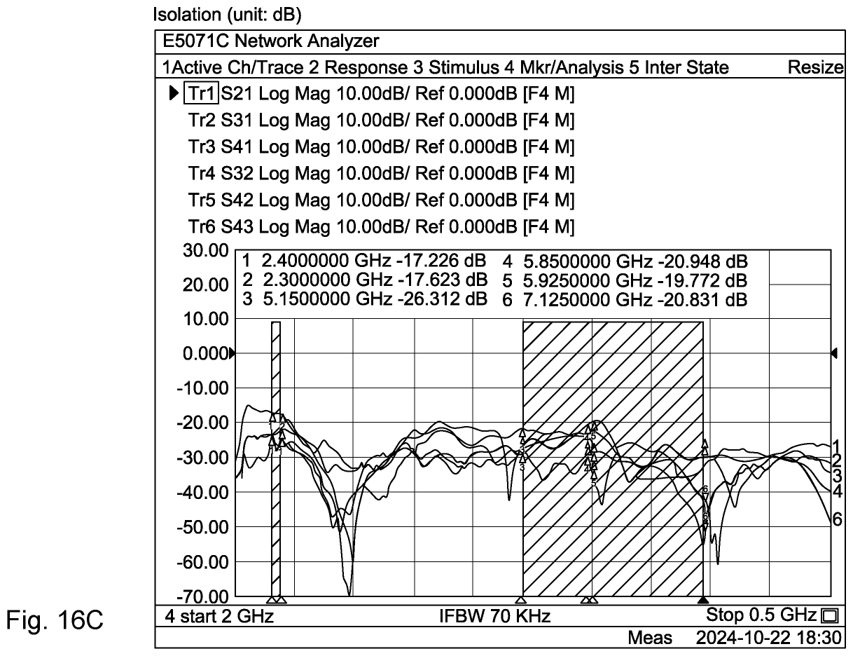

Performance of the antenna system of the present invention is depicted in FIGS. 16A, 16B, and 16C. FIG. 16A illustrates efficiency in two different frequency bands, FIG. 16B illustrates the voltage standing wave ratio (VSWR), and FIG. 16C illustrates isolation performance parameters of the WiFi antennas of the present invention.

The present invention discloses antenna coupling structures with parameters that can increase isolation between closely spaced simultaneously-operating antennas. Those skilled in the art recognize that it may be difficult to determine the best coupling structure parameters to minimize negative coupling and increase positive coupling. The inventors have determined that a properly trained artificial intelligence/machine learning (AI/ML) algorithm can provide appropriate parameters for a coupling structure that will optimize performance of closely-spaced antennas for a specific antenna design in a specific physical arrangement of the antennas.

Generally, to train an AI/ML algorithm (or later update the algorithm) data sets are input to the algorithm. The algorithm processes the data sets, and the resulting output is compared with an optimal or desired output. Prediction error is defined as the difference between the algorithm output and a desired output. A loss function computes the magnitude and direction of the prediction error and the prediction error is back-propagated through the network, updating a weight value associated with each element of the data set. Changing the weight values changes the prediction error to preferably reduce the prediction error during subsequent iterations of the algorithm. The algorithm is not a static function, but one that changes with each training episode by adjustment of the weights to reduce the prediction error.

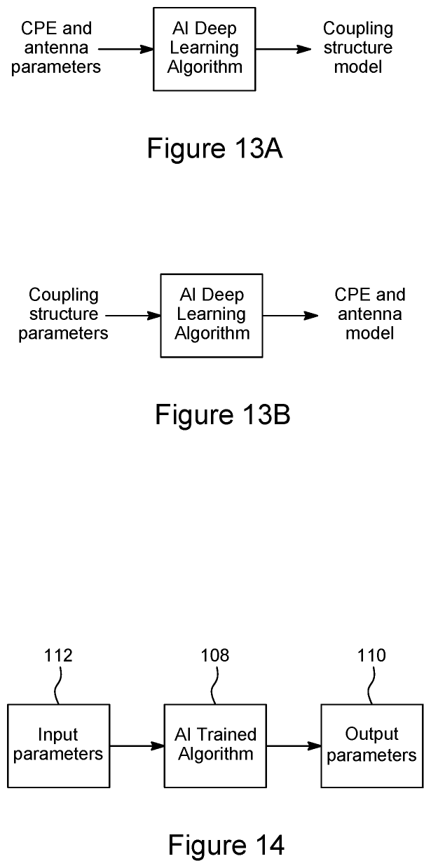

As applied to the present invention, the data sets comprise curated data from HSSS electromagnetic simulations. In one training process, CPE and antenna electrical and physical parameters are input to the AI/ML algorithm. The algorithm operates to optimize design parameters and dimensions by creating a model that includes details of the coupling structure (such as the coupling structures illustrated in FIGS. 5, 7, 8, 9, 10, and 11) that will increase isolation and introduce positive coupling, thereby improving overall antenna performance. See FIG. 13A.

The algorithm identifies patterns or makes predictions as to how certain ones of those electrical and physical parameters of the coupling structure affect the antenna isolation values. During the training process, the algorithm assigns weights to the input parameters, where a higher weight indicates that the parameter has a greater effect on the antenna isolation than does a parameter with a lower weight. The algorithm is executed until the antenna isolation values are maximized according to the loss function. Thus, the algorithm is “taught” and thereafter can be executed to generate more accurate coupling parameters based on other CPE designs and antenna parameters.

In lieu of identifying design parameters of the coupling elements, the AI/ML algorithm can instead provide design parameters for the CPE device and its antennas, again, to maximize isolation between simultaneously operating antennas. See FIG. 13B.

FIG. 14 depicts a trained Al algorithm 108 that generates output parameters 110 (coupling structure parameters or CPE and antenna parameters) based on inputs 112 that represent, conversely, the CPE and antenna parameters or the coupling structure parameters.

The AI/ML methodology can be executed in the context of computer-executable instructions, such as program modules, executed by a computer. Generally, program modules include routines, programs, objects, components, data structures, etc. that perform specific tasks or implement particular abstract data types. These software programs can be coded in different languages, for use with different processing platforms. It will be appreciated, however, that the principles that underlie the optimization process can be implemented with various types of computer hardware and software technologies.

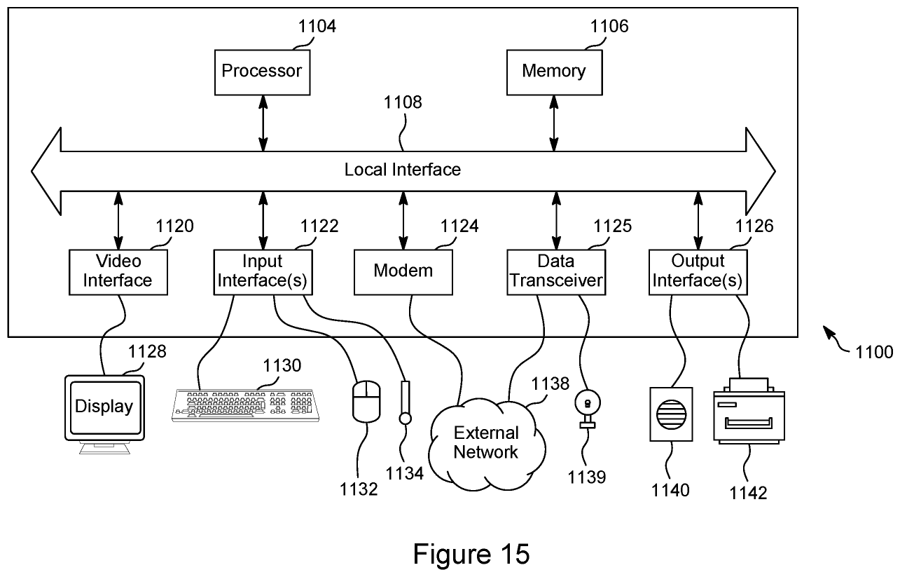

FIG. 15 illustrates a computer system 1100 for use in practicing the invention, including training the AI algorithm (FIGS. 13A and 13B) and using the trained Al algorithm of FIG. 14.

The system 1100 can include multiple remotely-located computers and/or processors and/or servers (not shown). The computer system 1100 comprises one or more processors 1104 for executing instructions in the form of computer code to carry out a specified logic routine that implements the teachings of the present invention.

The computer system 1100 further comprises a memory 1106 for storing data, software, logic routine instructions, computer programs, files, operating system instructions, and the like, as is well known in the art. The memory 1106 can comprise several devices, for example, volatile and non-volatile memory components further comprising a random-access memory RAM, a read only memory ROM, hard disks, floppy disks, compact disks including, but not limited to, CD-ROM, DVD-ROM, and CD-RW, tapes, flash drives, cloud storage, and/or other memory components. The system 1100 further comprises associated drives and players for these memory types.

In a multiple computer embodiment, the processor 1104 comprises multiple processors on one or more computer systems linked locally or remotely. According to one embodiment, various tasks associated with the present invention may be segregated so that different tasks can be executed by different computers/processors/servers located locally or remotely relative to each other.

The processor 1104 and the memory 1106 are coupled to a local interface 1108. The local interface 1108 comprises, for example, a data bus with an accompanying control bus, or a network between a processor and/or processors and/or memory or memories. In various embodiments, the computer system 1100 further comprises a video interface 1120, one or more input interfaces 1122, a modem 1124 and/or a data transceiver interface device 1125. The computer system 1100 further comprises an output interface 1126. The system 1100 further comprises a display 1128. The graphical user interface referred to above may be presented on the display 1128. The system 1100 may further comprise several input devices (some which are not shown) including, but not limited to, a keyboard 1130, a mouse 1131, a microphone 1132, a digital camera, smart phone, a wearable device, and a scanner (the latter two not shown). The data transceiver 1125 interfaces with a hard disk drive 1139 where software programs, including software instructions for implementing the present invention are stored.

The modem 1124 and/or data receiver 1125 can be coupled to an external network 1138 enabling the computer system 1100 to send and receive data signals, voice signals, video signals and the like via the external network 1138 as is well known in the art. The system 1100 also comprises output devices coupled to the output interface 1126, such as an audio speaker 1140, a printer 1142, and the like.

This Description of the Invention is not to be taken or considered in a limiting sense, and the appended claims, as well as the full range of equivalent embodiments to which such claims are entitled define the scope of various embodiments. This disclosure is intended to cover any and all adaptations, variations, or various embodiments. Combinations of presented embodiments, and other embodiments not specifically described herein by the descriptions, examples, or appended claims, may be apparent to those of skill in the art upon reviewing the above description and are considered part of the current invention.

What is claimed is:

1. An antenna system comprising:
first and second antennas disposed in a proximate relation and concurrently operative such that a first radiated field radiated by the first antenna impinges the second antenna, and a second radiated field radiated by the second antenna impinges the first antenna, thereby reducing effectiveness of the first and second radiated fields; and
a coupling structure comprising first and second conductive elements each comprising a terminal end and an open end, the terminal end of the first conductive element connected to the first antenna and the terminal end of the second conductive element connected to the second antenna, wherein surface currents flowing on the coupling structure increase effectiveness of the first and second radiated fields.

2. The antenna system of claim 1, wherein the first coupling structure comprises a first plurality of curved or linear segments or a first combination of curved and linear segments, and the second coupling structure comprises a second plurality of curved or linear segments or a second combination of curved and linear segments.

3. The antenna system of claim 1, wherein the first antenna comprises a first dipole antenna further comprising first and second dipole elements, and the second antenna comprises a second dipole antenna further comprising third and fourth dipole elements.

4. An enclosure for transmitting and receiving electromagnetic signals, the enclosure comprising:
a first and a second antenna disposed on a first surface of the enclosure and concurrently operative;
a first coupling structure comprising first and second conductive elements each further comprising a terminal end and an open end, the terminal end of the first conductive element connected to the first antenna and the terminal end of the second conductive element connected to the second antenna, wherein surface currents flowing on the first coupling structure increase effectiveness of the first and second radiated fields.
a third and a fourth antenna disposed on a second surface of the enclosure and concurrently operative, the second surface spaced apart from the first surface;
a second coupling structure comprising third and fourth conductive elements each further comprising a terminal end and an open end, the terminal end of the third conductive element connected to the third antenna and the terminal end of the fourth conductive element connected to the fourth antenna, wherein surface currents flowing on the second coupling structure increase effectiveness of the third and fourth radiated fields.

5. The enclosure of claim 4, wherein the first and second antennas operate according to a 2×2 MIMO protocol, the third and fourth antennas operate according to a 2×2 MIMO protocol, or the first, second, third, and fourth antennas operate according to a 4×4MIMO protocol.

6. The enclosure of claim 4, wherein the first, second, third, and fourth antennas each comprise a monopole antenna, a dipole antenna, a PIFA antenna, a patch antenna, or a meanderline antenna.

7. The enclosure of claim 4, wherein a shape of the first and second coupling structures each comprise a spiral shaped open-end loop.

8. The enclosure of claim 4, wherein a shape of each of the first and second coupling structures comprises a plurality of coupled linear segments or a plurality of coupled curved segments.

9. The enclosure of claim 4, wherein a shape of the coupling structure comprises an open parallelogram or an open spiral.

10. The enclosure of claim 9, wherein the open parallelogram comprises four linear segments, and wherein each one of the four linear segments is connected to an adjacent linear segment at a right angle.

11. The enclosure of claim 4, wherein the first coupling structure reduces a value of an S21 parameter or a value of an S12 parameter at one or more frequencies for the first and second antennas, and wherein the second coupling structure reduces a value of an S21 parameter or a value of an S12 parameter at one or more frequencies for the third and fourth antennas.

12. A parallelepiped-shaped enclosure for transmitting and receiving electromagnetic signals according to a first and a second protocol, the enclosure comprising:
a first and a second antenna disposed on a first surface of the enclosure and concurrently operative, wherein each one of the first and second antennas produces a radiated field;
a first coupling structure comprising first and second conductive elements each further comprising a terminal end and an open end, the terminal end of the first conductive element connected to the first antenna and the terminal end of the second conductive element connected to the second antenna, wherein surface currents flowing on the first coupling structure increase effectiveness of the first and second radiated fields;
a third and a fourth antenna disposed on a second surface of the enclosure and concurrently operative, the second surface spaced apart from the first surface;
a second coupling structure comprising third and fourth conductive elements each further comprising a terminal end and an open end, the terminal end of the third conductive element connected to the third antenna and the terminal end of the fourth conductive element connected to the fourth antenna, wherein surface currents flowing on the second coupling structure increase effectiveness of the third and fourth radiated fields;
fifth and sixth antennas each producing a respective fifth and a sixth radiated field, the fifth and sixth antennas disposed in a spaced apart relation on a third surface of the enclosure such that minimal interference is produced between the fifth and sixth radiated fields when the fifth and sixth antennas operate simultaneously;
seventh and eighth antennas each producing a respective seventh and eighth radiated field, the seventh and eighth antennas disposed in a spaced apart relation on a fourth surface of the enclosure, the fourth surface spaced apart from the third surface, such that minimal interference is produced between the seventh and eighth radiated fields when the seventh and eighth antennas operate simultaneously;
wherein the first, second, third, and fourth antennas operate according to a first communications protocol; and
wherein the fifth, sixth, seventh and eighth antennas operate according to a second communications protocol.

13. The enclosure of claim 12, wherein the first communications protocol comprises a cellular communications protocol and the second communications protocol comprises a WiFi communications protocol.

14. The enclosure of claim 12, wherein the first, second, third, and fourth surfaces are rectangular in shape.

15. The enclosure of claim 12, wherein a shape of the first and second conductive structures each comprises a first and second open-ended loop, and wherein the first and second open ended loops have a common center and an identical length.

16. The enclosure of claim 12, wherein the first, second, third, and fourth antennas operate according to a first 4×4 MIMO communications protocol and wherein the fifth, sixth, seventh and eighth antennas operate according to a second 4×4 MIMO communications protocol.

17. The enclosure of claim 12, wherein the first, second, third, fourth, fifth, sixth, seventh, and eighth antennas each comprise a dipole antenna, a monopole antenna, a meanderline antenna, a patch antenna, or a PIFA antenna.

18. The enclosure of claim 12, wherein the first, second, third, and fourth surfaces each comprise a square surface or a rectangular surface.

19. The enclosure of claim 12, wherein a shape of the first and second coupling structures each comprise a spiral shaped open-end loop, a plurality of coupled linear segments, or a plurality of coupled curved segments.

20. The enclosure of claim 12, wherein the first coupling structure reduces a value of an S21 parameter or a value of an S12 parameter at one or more frequencies for the first and second antennas, and wherein the second coupling structure reduces a value of an S21 parameter or a value of an S12 parameter at one or more frequencies for the third and fourth antennas.
